(19) United States
(12) Patent Application Publication
(10) Pub. No.: US 2002/0184034 A1
(43) Pub. Date: Dec. 5, 2002

(54) Hypersound document

(75) Inventor: Tetsuya Yamamoto, Chiba (JP)

Correspondence Address: COHEN, PONTANI, LIEBERMAN & PAVANE, 551 Fifth Avenue, Suite 1210, New York, NY, 10176, US

(73) Assignee: Nokia Corporation

(21) Appl. No.: 10/154,289

(22) Filed: May 23, 2002

(30) Foreign Application Priority Data
May 30, 2001 (JP) H2001-163325

(51) Int. Cl. G10L 21/00

(52) U.S. Cl. 704/270.1

(57) ABSTRACT

A hypersound document which insures reductions in cost and power requirement of electronic information terminals and a reproducer therefor. The hypersound document has plural pieces of voice data, a time table, and link destinations therein. In an embodiment shown in FIG. 1, “Sound1” for a piece of voice data, a start (t1) and an end (T1) for a time table, and “URL1” for a link destination are associated and stored.

### BACKGROUND OF THE INVENTION

1. Field of the Invention

The present invention relates to a hypersound document and a reproducer therefor, and more particularly to a hypersound document which allows inter-document movement and hearing by a speaker and key operations without a display and a reproducer therefor.

2. Description of the Related Art

In the past, electronic information terminals have been based on visual human interfaces. Although the visual interface is most effective, the display is expensive and consumes a large amount of electric power.

Many people overtax one's eyes in our time because of much visual information such as TV broadcasts, printed matter including newspapers, magazines, and novels, video games, PCs, and CADs. As a result, they become less willing to obtain still more information increasing day by day with their eyes.

It is an object of the invention to provide a hypersound document that can offer a lower-cost and power-thrifty electronic information terminal and a reproducer therefor.

It is another object of the invention to provide a hypersound document for avoiding eyestrain of users and a reproducer therefor.

### SUMMARY OF THE INVENTION

To solve the foregoing problems, the invention provides a hypersound document constituted a piece of voice data logically split into a plurality of parts by a time table and descriptor data defining link destinations of the individual parts.

The link destinations of the hypersound document may be other hypersound documents.

In addition, the invention provides a reproducer for a hypersound document constituted a piece of voice data logically split into a plurality of parts by a time table and descriptor data defining link destinations of the individual parts. The reproducer comprises a user-operating unit for generating a trigger and a reproduction unit for reproducing link destinations of the part which was in course of reproduction at the time of generation of the trigger.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the strictures and procedures described herein.

### BRIEF DESCRIPTION OF THE DRAWINGS

In the drawings:

FIG. 1 is a conceptual drawing of a hypersound document of an embodiment according to the invention;

FIG. 2 is a diagram showing a piece of voice data sample in an embodiment of the invention;

FIG. 3 is a front view showing an operation panel of a reproducer of an embodiment of the invention; and

FIG. 4 is a conceptual drawing of a hypersound document of an embodiment of the invention.

### DETAILED DESCRIPTION OF THE PRESENTLY PREFERRED EMBODIMENTS

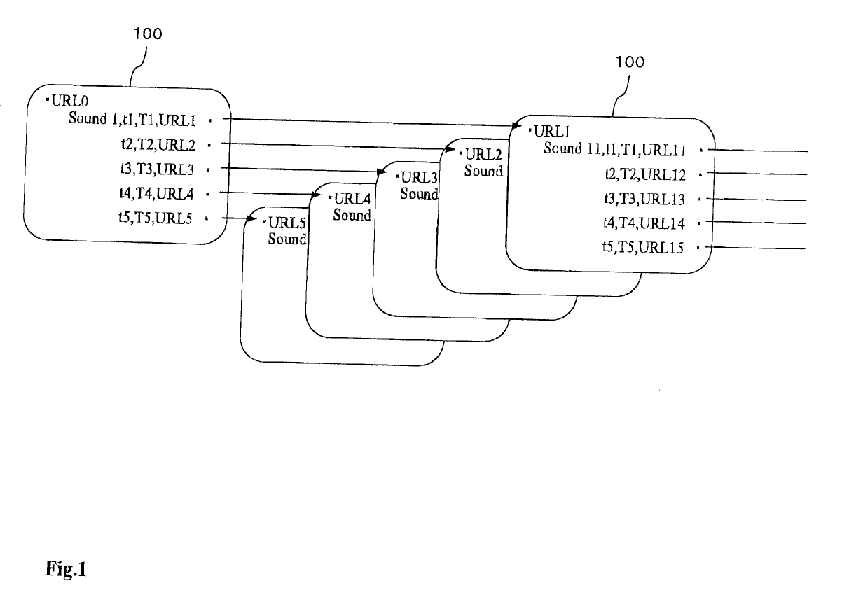

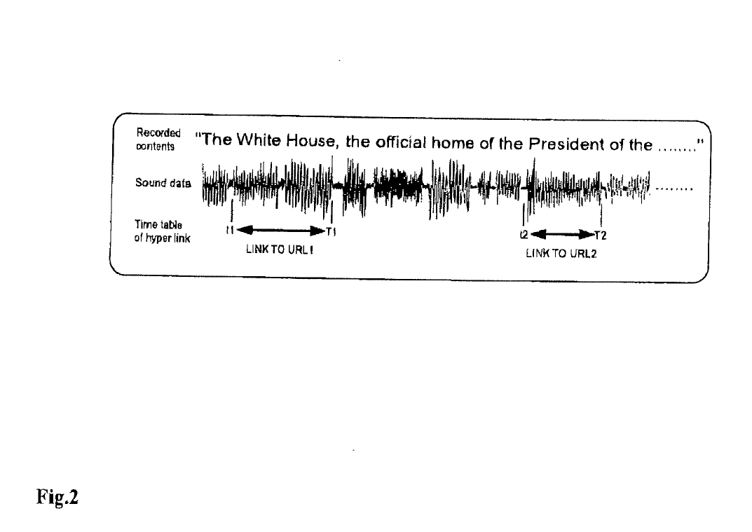

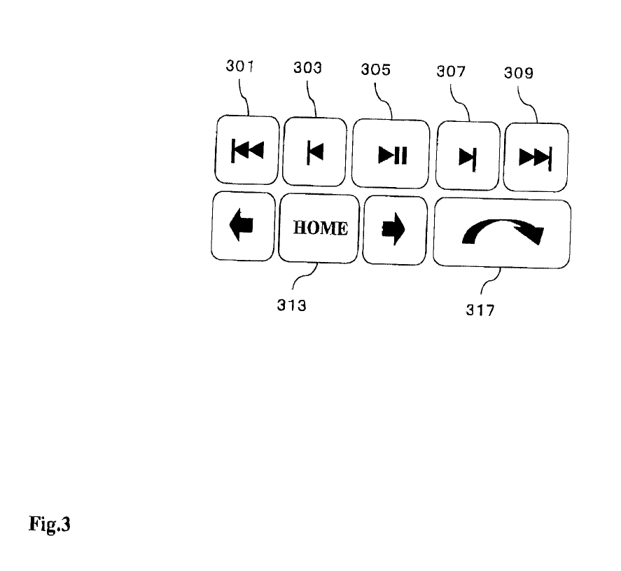

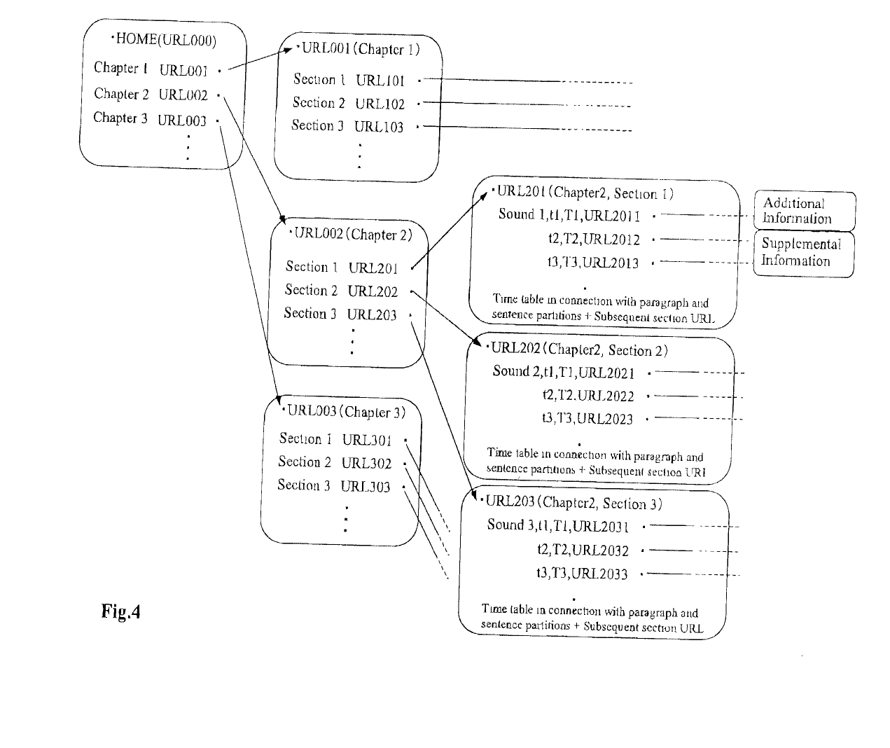

The embodiments of the invention will be described in detail with reference to FIGS. 1 to 4, wherein FIG. 1 is a conceptual drawing of a hypersound document; FIG. 2 is a diagram showing a piece of voice data sample; FIG. 3 is a front view showing an operation panel of a hypersound document reproducer; and FIG. 4 is a conceptual drawing in a case where a group of hypersound documents are applied to a novel.

Referring now to FIG. 1, there is shown a concept of a hypersound document of an embodiment of the invention. As shown in FIG. 1, in a hypersound document 100 of an embodiment of the invention, a piece of voice data, plural pieces of interval data, and link destinations are associated therewith and defined. In the embodiment shown in FIG. 1, “Sound1” for voice data, a start (t1: t1 milliseconds after reproducing start, for example) and an end (T1: T1 milliseconds after reproducing start) for interval data, and “URL1” for a link destination are associated and stored. Likewise, a start (t2) and an end (T2) for second interval data and “URL2” for a link destination are associated and stored. “URL1” and “URL2” are also hypersound documents and URL1 to URLn each have a respective hierarchical structure or network structure.

Referring now to FIG. 2, there is illustrated a piece of voice data sample. Waveforms in the middle section thereof show voice data and they can be reproduced, as shown in the upper section, in fact as follows: “The White House, the official home of the President of the . . . . ” It is recorded in a lower section time table that a time interval from t1 just short of reproduction of “White House” to T1 immediately after reproducing so is linked to URL1. Also, it is recorded in the time table that a time interval from t2 just short of reproduction of “President” to T2 immediately after reproducing so is linked to URL2. For example, when a user has a trigger generated with an operation switch or the like during or immediately after the reproduction of “White House” in “The White House, the official home of the President of the . . . ”, which can be selected on a contents site or hardware site, the current hypersound document moves to a hypersound document URL1 of a link destination, and in turn reproduction of voice data stored in the document is started. Therefore, for instance, it may be possible to provide a hypersound document having a function as a dictionary by storing starting and terminating locations of an abbreviation in voice data (e.g. “FOMC”) in a time table and setting as its link destination a hypersound document where voice data representing a translation of the abbreviation (in this case, Federal Open Market Committee) is stored.

In addition, it may be also possible to provide a hypersound document having a function like a voice guidance by stratifying a plurality of hypersound documents. By way of example, the case will be hereinafter described where information concerning various parts of a country is provided by administrative divisions, such as the prefectures plus Tokyo, Hokkaido, Osaka, and Kyoto of Japan.

[1] The Creation of Hypersound Document for the Main Menu

(1) A piece of voice data consisting of “Hokkaido, Tohoku, Kanto, Kinki, Kansai, and so on . . . ” is separated by districts and the respective reproduction starting and terminating locations are stored in a time table.

(2) Link destinations for the names of districts resulting from the separation with the time table (hypersound documents for sub-menus in this case) are defined.

[2] The Creation of Hypersound Document for Sub-Menus

(1) A piece of voice data consisting of “Tokyo, Kanagawa-prefecture, Chiba-prefecture, Saitama-prefecture, and so on . . . ” is separated by administrative divisions such as the prefectures and Tokyo and the respective reproduction starting and terminating locations are stored in a time table.

(2) Link destinations for the names of administrative divisions resulting from the separation with the time table (hypersound documents storing voice information concerning the administrative divisions in this case) are defined.

[3] An Example of Operation

(1) A user can generate triggers, for example, by pressing an operation switch during or immediately after the reproduction of a desired district name (e.g. Kanto), since it is reproduced as “Hokkaido, Tohoku, Kanto, Kinki, Kansai, and so on . . . ” when a user accesses a hypersound document for the main menu.

(2) Then, since the current hypersound document moves to a hypersound document for sub-menus and subsequently it is reproduced as “Tokyo, Kanagawa-prefecture, Chiba-prefecture, Saitama-prefecture, and so on . . . ,” the user can generate triggers, for example, by pressing an operation switch during or immediately after the reproduction of a desired administrative division name, namely a prefecture name or Tokyo (here, e.g. Tokyo).

(3) Voice information concerning Tokyo is reproduced.

With reference to FIGS. 3 and 4, an embodiment of a hypersound document reproducer will be described below. First, FIG. 4 is a conceptual drawing in the case where a group of hypersound documents are applied to a novel. Initially, on accessing a document in a home (a table of contents), titles of all chapters (Chapters 1 to 3) are reproduced. Pressing a switch 317 during the reproduction of the title of the chapter that the user desires, the user can move to the section branching document of the desired chapter (URL001-URL003 in FIG. 4).

The section branching document also includes voice data (Paragraph 1 title, Paragraph 2 title, Paragraph 3 title, and so on . . . ). Accessing the data causes the section titles to be reproduced. Further, pressing a switch 317 during the reproduction of the title of the section that the user desires, the user can move to a hypersound document corresponding to the section (URL201-URL203 in FIG. 4). The hypersound document stores the sentences of all sections in the form of a piece of voice data and has a time table in connection with the ends of a paragraph and sentence and a subsequent section URL in addition to the above-described link destinations (e.g. link destinations for annotations, additional information, and supplemental information).

FIG. 3 shows an embodiment of an operation panel of the reproducer, wherein pressing each switch 301-317 produces the action as described in the following cases 1 to 7.

1. In the Case of Pressing a Switch 301 During the Reproduction of URL202 (Section 2 of Chapter 2)

[1] A jump to the section branching document (URL001) of Chapter 1 takes place, where Chapter 1 is the immediately preceding chapter of Chapter 2 which the current hypersound document (URL202) belongs to; and

[2] The titles of all sections belonging to Chapter 1 are reproduced.

2. In the Case of Pressing a Switch 303 During the Reproduction of URL202 (Section 2 of Chapter 2)

[1] The immediately preceding sentence of the current sentence in course of reproduction is reproduced.

3. In the Case of Pressing a Switch 305 During the Reproduction of URL202 (Section 2 of Chapter 2)

[1] The reproduction is stopped temporarily; and

[2] The reproduction is continued from where it was stopped when the switch 305 is pressed again.

4. In the Case of Pressing a Switch 307 During the Reproduction of URL202 (Section 2 of Chapter 2)

[1] The sentence following the current sentence in course of reproduction is reproduced.

5. In the Case of Pressing a Switch 309 During the Reproduction of URL202 (Section 2 of Chapter 2)

[1] A jump to the section branching document (URL003) of Chapter 3 takes place, where Chapter 3 is the chapter following Chapter 2 which the current hypersound document (URL202) belongs to; and

[2] The titles of all sections belonging to Chapter 3 are reproduced.

6. In the Case of Pressing a Switch 313

[1] A jump to the hypersound document of the home (e.g. a table of contents) takes place.

7. In the Case of Pressing a Switch 317

[1] When the current voice data in course of reproduction has any hypersound document linked thereto, a jump to the hypersound document takes place.

While the invention has been described in the context of preferred embodiments, it is not limited by the above description and may be applied to, for example, newspapers, language learning, bidirectional broadcasting, digital household electrical appliances for connecting into the Internet, and manufactured articles for visually impaired persons.

Further, while the embodiments of the invention have been described above, the invention provides the following advantages:

1. Since no display is used, it is possible to perform anything else while obtaining information.

2. Since no display is used, it is possible tc cut down on costs.

3. It is possible to ensure reductions in size and power requirement of a portable terminal.

4. It is possible to provide bidirectional voice information.

5. It is possible to provide a digital household electrical appliance which is easy to operate for visually impaired persons.

6. It is possible to provide a web site which is easy to access for visually impaired persons.

Therefore, according to the invention, it is possible to provide a hypersound document that insures reductions in cost and power requirement of electronic information terminals and a reproducer therefor.

In addition, according to the invention, it is possible to provide a hypersound document for avoiding eyestrain of users and a reproducer therefor.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hypersound document comprising a piece of voice data logically split into a plurality of parts by a time table and descriptor data defining link destinations of the individual parts.

2. The hypersound document of claim 1, wherein the link destinations are other hypersound documents.

3. A reproducer for reproducing a hypersound document comprised of a piece of voice data logically split into a plurality of parts by a time table and descriptor data defining link destinations of the individual parts, comprising:
a user-operating unit for generating a trigger; and
a reproduction unit for reproducing link destinations of the part which was in course of reproduction at the time of generation of the trigger.
